(19) United States
(12) Patent Application Publication
(10) Pub. No.: US 2017/0032725 A1
(43) Pub. Date: Feb. 2, 2017

(54) METHOD, DEVICE, AND COMPUTER-READABLE MEDIUM FOR SETTING COLOR GAMUT MODE

(71) Applicant: Xiaomi Inc., Beijing (CN)

(72) Inventors: Guosheng LI, Bejing (CN); Anyu LIU, Beijing (CN); Zhengdong XIAO, Beijing (CN)

(73) Assignee: Xiaomi Inc., Beijing (CN)

(21) Appl. No.: 15/052,220

(22) Filed: Feb. 24, 2016

(30) Foreign Application Priority Data
Jul. 28, 2015 (CN) 201510450942.4

(51) Int. Cl. G09G 3/20

(52) U.S. Cl. CPC G09G 3/2003; G09G 2320/0242; G09G 2320/0666

(57) ABSTRACT

Aspects of the disclosure provide a method for setting a color gamut mode for driving a display. The method includes acquiring a first picture to be displayed on the display; determining a picture type of the first picture, the picture type being associated with a predetermined color gamut mode; acquiring a current color gamut mode currently adopted for driving the display; and when the picture type of the first picture does not match the current color gamut mode, switching the color gamut mode for driving the display from the current color gamut mode to the predetermined color gamut mode.

### CROSS-REFERENCE TO RELATED APPLICATION

This application bases on and claims priority of the Chinese Patent Application No. 201510450942.4 filed on Jul. 28, 2015, which is incorporated by reference in its entirety.

### TECHNICAL FIELD

The present disclosure generally relates to the field of image processing technology, and more particularly, to a method, a device, and a computer-readable medium for setting color gamut mode

### BACKGROUND

Color gamut refers to the color space that can be expressed by a device, i.e., the ranges of colors that can be expressed by display devices, printers, or printing presses, etc. With the development of display technology, the color gamut of a display of a mobile terminal, such as a mobile phone, has exceeds a color space recommended by National Television Standards Committee (NTSC). In many applications, a display is driven according to a standard Red Green Blue (sRGB) color gamut mode when displaying images obtained over the Internet. The sRGB color gamut mode covers only 70.8% of the color space recommended by NTSC and can still offer reasonable viewing experiences for various types of images generated by still cameras or video cameras. Nonetheless, different types of pictures may correspond to different color gamut modes in order to achieve optimal display effects.

### SUMMARY

Aspects of the disclosure provide a method for setting a color gamut mode for driving a display. The method includes acquiring a first picture to be displayed on the display; determining a picture type of the first picture, the picture type being associated with a predetermined color gamut mode; acquiring a current color gamut mode currently adopted for driving the display; and when the picture type of the first picture does not match the current color gamut mode, switching the color gamut mode for driving the display from the current color gamut mode to the predetermined color gamut mode.

In an embodiment, determining the picture type of the first picture includes determining the picture type of the first picture according to frequency domain information of the first picture.

In an embodiment, determining the picture type of the first picture according to frequency domain information of the first picture includes: performing Fourier transformation on the first picture to acquire the frequency domain information; and determining the picture type of the picture according to a relationship between the frequency domain information and a predetermined threshold. In an embodiment, determining the picture type includes: determining the picture type being the natural type when all normalized amplitude values of the frequency domain information are less than the predetermined threshold, and determining the picture type being the composite type when at least one normalized amplitude value of the frequency domain information is greater than the predetermined threshold.

Aspects of the disclosure provide a device for setting a color gamut mode for driving a display. The device includes a processor and a memory storing instructions executable by the processor. The processor is configured to acquire a first picture to be displayed on the display, determine a picture type of the picture, the picture type being associated with a predetermined color gamut mode, acquire a current color gamut mode currently adopted for driving the display, and when the picture type of the first picture does not match the current color gamut mode, switch the color gamut mode for driving the display from the current color gamut mode to the predetermined color gamut mode.

In an embodiment, when determining the picture type of the first picture, the processor is configured to: perform Fourier transformation on the first picture to acquire the frequency domain information, and determine the picture type of the picture according to a relationship between the frequency domain information and a predetermined threshold. In one embodiment, when determining the picture type of the first picture, the processor is configured to determine the picture type being the natural type when all normalized amplitude values of the frequency domain information are less than the predetermined threshold, and determine the picture type being the composite type when at least one normalized amplitude value of the frequency domain information is greater than the predetermined threshold.

Aspects of the disclosure provide a non-transitory computer-readable medium having recorded thereon a computer program including instructions. The instructions, which when executed by a computer, cause the computer to perform a method, and the method comprises: acquiring a first picture to be displayed on a display; determining a picture type of the first picture, the picture type being associated with a predetermined color gamut mode; acquiring a current color gamut mode currently adopted for driving the display; and when the picture type of the first picture does not match the current color gamut mode, switching a color gamut mode for driving the display from the current color gamut mode to the predetermined color gamut mode.

In an embodiment, determining the picture type of the first picture according to frequency domain information of the first picture includes: performing Fourier transformation on the first picture to acquire the frequency domain information; and determining the picture type of the picture according to a relationship between the frequency domain information and a predetermined threshold. In an embodiment, determining the picture type includes: determining the picture type being the natural type when all normalized amplitude values of the frequency domain information are less than the predetermined threshold, and determining the picture type being the composite type when at least one normalized amplitude value of the frequency domain information is greater than the predetermined threshold.

### BRIEF DESCRIPTION OF THE DRAWINGS

The accompanying drawings, which are incorporated in and constitute a part of this disclosure, illustrate embodiments in accordance with the present disclosure and, together with the detailed description, serve to explain the principles of various features of the present disclosure.

FIG. 1 is a flow chart of an example method for setting a color gamut mode according to an embodiment of the disclosure.

FIG. 2A is an example composite type picture according to an embodiment of the disclosure.

FIG. 2B is another example composite type picture according to an embodiment of the disclosure.

FIG. 3 is a diagram of a mobile phone and a server according to an embodiment of the disclosure.

FIG. 4 is a flow chart of another example method for setting a color gamut mode according to an embodiment of the disclosure.

FIG. 5 is a flow chart of another example method for setting a color gamut mode according to an embodiment of the disclosure.

FIG. 6 is a flow chart of another example method for setting a color gamut mode according to an embodiment of the disclosure.

FIG. 7 is a flow chart of yet another example method for setting a color gamut mode according to an embodiment of the disclosure.

FIG. 8 is a block diagram of an example device for setting a color gamut mode according to an embodiment of the disclosure.

FIG. 9 is a block diagram of an example determining module in a device for setting a color gamut mode according to an embodiment of the disclosure.

FIG. 10A is a block diagram of another example device for setting a color gamut mode according to an embodiment of the disclosure.

FIG. 10B is a block diagram of another example device for setting a color gamut mode according to an embodiment of the disclosure.

FIG. 11A is a block diagram of another example device for setting a color gamut mode according to an embodiment of the disclosure.

FIG. 11B is a block diagram of yet another example device for setting a color gamut mode shown according to an embodiment of the disclosure.

FIG. 12 is a block diagram of an example apparatus usable as a device for setting a color gamut mode according to an embodiment of the disclosure.

### DETAILED DESCRIPTION

Reference will now be made in detail to various embodiments, examples of which are illustrated in the accompanying drawings. The following description refers to the accompanying drawings in which same numbers in different drawings represent same or similar elements unless otherwise described. The implementations set forth in the following description of various embodiments do not represent all implementations consistent with various features disclosed in the present disclosure. Instead, they are merely examples of apparatuses and methods consistent with various features disclosed in the present disclosure.

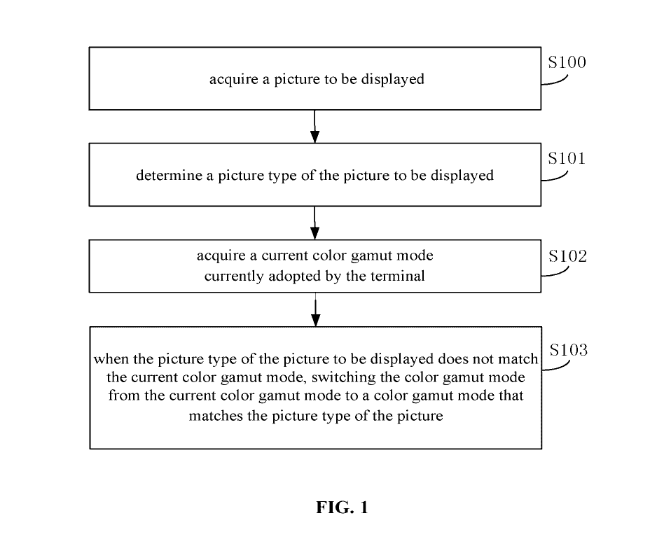

FIG. 1 is a flow chart of an example method for setting a color gamut mode according to an embodiment. In some embodiments, the method for setting a color gamut mode as shown in FIG. 1 may be performed by a terminal such as a mobile phone, a tablet computer, etc. The method as shown in FIG. 1 may include the following steps S100-S103.

In step S100, a picture to be displayed by a display of a terminal may be acquired.

In some embodiments, the terminal may acquire a picture to be displayed from a server or locally from a storage device of the terminal. In one example, when a user operates the terminal to view a picture of a certain piece of clothes from an online shop, the terminal may acquire the picture of the clothes from a server. In another example, when a user operates the terminal to view a picture saved locally in the storage device of the terminal, the terminal may acquire the picture from a local album in the storage device.

In step S101, a picture type of the picture to be displayed may be determined.

In some embodiments, the above picture type may include a natural type and a composite type.

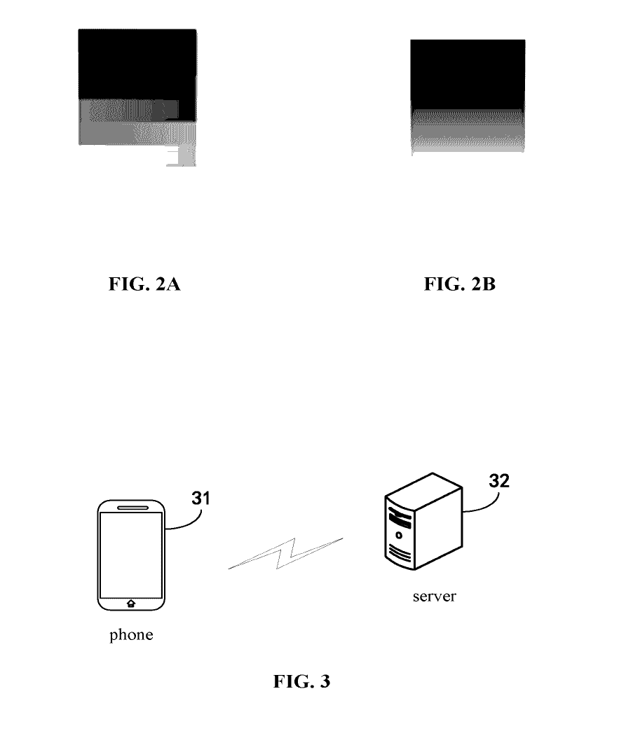

One characteristic of a composite type picture is that grayscale values of adjacent pixels in the picture have discernable regularities, such as a gradual change, duplication of patterns, discontinuities with a constant difference, etc. The pictures as shown in FIGS. 2A-2B are example composite type pictures, and their grayscale values of adjacent pixels have relatively discernable regularities. In contrast, one characteristic of a natural type picture is that grayscale values of adjacent pixels in the picture do not have discernable regularities.

Performing Fourier transformation on the picture may transform a grayscale distribution of the picture into a frequency domain distribution of the picture. For a natural type picture, frequency domain information obtained after Fourier transformation demonstrates a pseudo-random distribution without obvious regularity. In some examples, all normalized amplitude values of the frequency domain information are less than a predetermined threshold. In contrast, for a composite type picture, frequency domain information obtained after Fourier transformation may include some discernable peak amplitude values. In some examples, at least one normalized amplitude value of the frequency domain information is greater than the predetermined threshold. Therefore, a picture type of the picture may be determined according to frequency domain information of the picture as discussed above.

For example, in S101, Fourier transformation may be performed on the picture to be displayed to acquire the frequency domain information thereof. When all normalized amplitude values of the frequency domain information are less than the predetermined threshold, the picture type of the picture may be determined as the natural type. When at least one normalized amplitude value of the frequency domain information is greater than the predetermined threshold, the picture type of the picture may be determined as the composite type.

In step S102, a current color gamut mode currently adopted by the terminal for driving the display may be acquired. In some embodiments, each picture type is associated with a respective, predetermined color gamut mode.

In at least one embodiment, the display of the terminal may support both sRGB color gamut mode as well as a wide color gamut mode that corresponds to a color space wider than that of the sRGB color gamut mode.

The natural type may be associated with a first color gamut mode, and the composite type may be associated with a second color gamut mode that corresponds to a wider color space than the first color gamut mode. In some examples, the first color gamut mode is the sRGB color gamut mode, and the second color gamut mode is the wide color gamut mode.

In step S103, if the picture type of the picture does not match the current color gamut mode, the color gamut mode for driving the display may be switched from the current color gamut mode to a color gamut mode which matches the picture type of the picture to be displayed. In some embodiments a picture type matches a color gamut mode when the picture type is associated with the color gamut mode; and a picture type does not match a color gamut mode when the picture type is not associated with the color gamut mode.

In some embodiments, the predetermined color gamut of the picture type of the picture to be displayed may be compared with the current color gamut mode. If they do not match with each other, the terminal may switch the color gamut mode from the current color gamut mode to a color gamut mode which matches the predetermined color gamut of the picture type of the picture to be displayed. If they match with each other, there is no need to switch color gamut mode.

In one example, when the picture type is a natural type and the current color gamut mode for driving the display is wide color gamut mode, the color gamut mode of the picture type does not match the current color gamut mode, and the color gamut mode for driving the display may be switched from the wide color gamut mode to the sRGB color gamut mode.

In another example, when the picture type is a composite type and the current color gamut mode for driving the display is the sRGB mode, the color gamut mode of the picture type does not match the current color gamut mode, and the color gamut mode for driving the display may be switched from the sRGB color gamut mode to the wide color gamut mode.

FIG. 3 is a diagram of a mobile phone 31 and a server 32 according to an embodiment of the disclosure. As shown in FIG. 3, a user may browse icons or thumbnails of clothes in an online shop such as Xiaomi mall with the mobile phone 31 and operates the mobile phone 31 to enter a page of a certain piece of clothes of interest. When the user operates the mobile phone 31 to click on an icon or thumbnail of the clothes, the mobile phone 31 may send a request to the server 32 of the online shop in order to obtain a picture corresponding to the clicked icon or thumbnail. The server 32 then may return a page containing a picture of the clothes upon the request.

In one example, after acquiring the picture of the clothes, the mobile phone 31 may determine that the picture is a natural type picture. However, the color gamut mode currently adopted by the mobile phone 31 is the wide color gamut mode. Since a natural picture type corresponds to the sRGB color gamut mode for accurate expression on the display, the natural type picture does not match the wide color gamut mode. Therefore, the mobile phone 31 may switch the color gamut mode from the wide color gamut mode to the sRGB color gamut mode, and use the switched sRGB mode to drive the display to display the picture of the clothes. Accordingly, the picture of the clothes can be displayed without color distortion, and the displayed picture can provide the user with reliable color information for determining whether to purchase the clothes or not. Thus, the user viewing experiences may be improved.

With the above embodiment of the method for setting the color gamut mode, by acquiring a picture to be displayed, determining a picture type of the picture, and setting a current color gamut mode to a color gamut mode which matches the determined picture type of the picture to be displayed, the whole mode setting procedure can be performed automatically even when a user does not possess professional knowledge with respect to setting color gamut mode. Meanwhile, by adopting a matching color gamut mode based on a picture type of a picture, the colors of the picture can be displayed with the accuracy a user might expect, and the user viewing experiences may be improved.

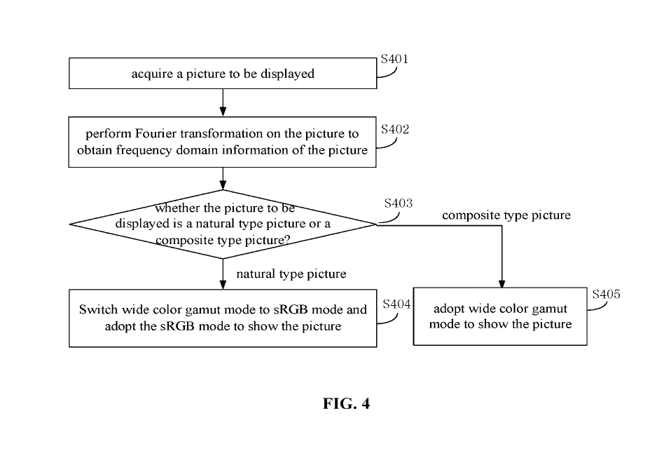

FIG. 4 is a flow chart of another example method for setting a color gamut mode according to an embodiment of the disclosure. In some embodiments, the method for setting a color gamut mode as shown in FIG. 4 may be performed by a terminal such as a mobile phone, a tablet computer, etc. In this embodiment, the color gamut mode currently adopted by the terminal is a wide color gamut mode. As shown in FIG. 4, the method for setting a color gamut mode may include the following steps.

In step S401, a picture to be displayed by a display of the terminal may be acquired.

In step S402, Fourier transformation may be performed on the picture to be displayed to acquire frequency domain information of the picture to be displayed.

In step S403, whether the picture to be displayed is a natural type picture or a composite type picture may be determined according to a relationship between the frequency domain information of the picture to be displayed and a predetermined threshold. When the picture is determined to be a natural type picture, the process proceeds to step S404; and when the picture is determined to be a composite type picture, the process proceeds to step S405.

In step S404, the terminal may switch the color gamut mode for driving the display of the terminal from the wide color gamut mode to sRGB color gamut mode, and the sRGB mode may be adopted to drive the display when displaying the picture.

In step S405, the wide color gamut mode may be adopted to drive the display when displaying the picture.

The above embodiment of the method for setting a color gamut mode performs Fourier transformation on a picture to be displayed to acquire frequency domain information of the picture and determines a picture type of the picture according to a relationship between frequency domain information of the picture and a predetermined threshold. Accordingly, the disclosed embodiments determine the picture type of the picture based on the differences between the characteristics of a natural type and a composite type, which can be easily implemented with high accuracy. Also, after determining the picture as a natural type picture, the terminal switches a color gamut mode from the wide color gamut mode to the sRGB mode and adopts the sRGB mode to show the picture, thus the picture can be displayed with accurate colors, and the user viewing experiences may be improved.

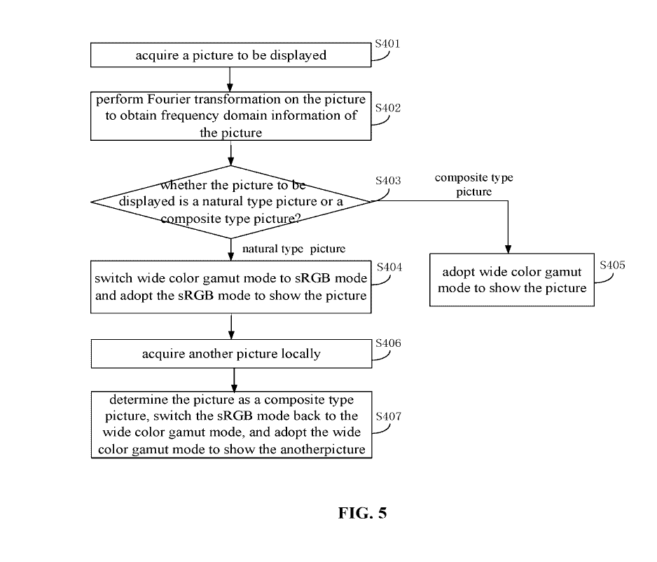

FIG. 5 is a flow chart of another example method for setting a color gamut mode shown according to an embodiment of the disclosure. As shown in FIG. 5, after step S404, the method may further include the following steps.

In step S406, another picture may be acquired by the terminal locally from a storage device of the terminal.

In step S407, the another picture may be determined as a composite type picture, and the color gamut mode may be switched from the sRGB mode back to the wide color gamut mode, and the wide color gamut mode may be adopted to show the another picture.

The above embodiment of the method for setting color gamut mode switches the color gamut mode from the sRGB mode back to the wide color gamut mode and adopts the wide color gamut mode to show another picture after determining that the another picture as a composite type picture Thus, the another picture can be displayed with vivid colors, the user viewing experiences may be improved.

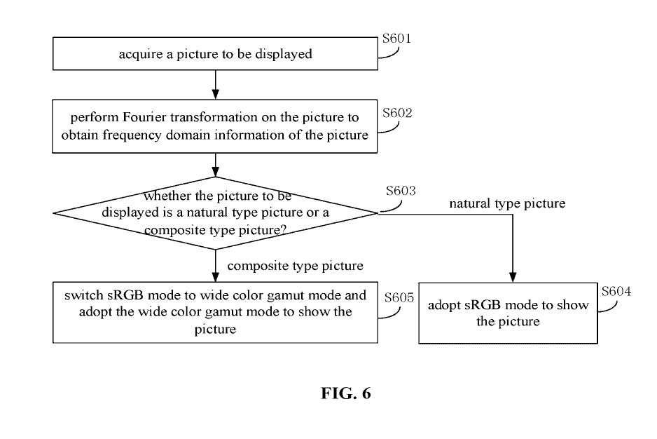

FIG. 6 is a flow chart of another example method for setting a color gamut mode according to an embodiment. In some embodiments, the method may be performed by a terminal such as a mobile phone, a tablet computer, etc. In this embodiment, the color gamut mode currently adopted by the terminal is the sRGB mode. As shown in FIG. 6, the method for setting a color gamut mode may include the following steps.

In step S601, a picture to be displayed by a display of the terminal may be acquired.

In step S602, Fourier transformation may be performed on the picture to be displayed to acquire frequency domain information of the picture to be displayed.

In step S603, whether the picture to be displayed is a natural type picture or a composite type picture may be determined according to a relationship between the frequency domain information of the picture to be displayed and a predetermined threshold. When the picture is determined to be a natural type picture, the process proceeds to step S604; and when the picture is determined to be a composite type picture, the process proceeds to step S605

In step S604, the sRGB mode may be adopted to drive the display when displaying the picture.

In step S605, the terminal may switch the color gamut mode for driving the display of the terminal from the sRGB mode to the wide color gamut mode, and the wide color gamut mode may be adopted to drive the display when displaying the picture.

The above embodiment of the method for setting a color gamut mode performs Fourier transformation on a picture to be displayed to acquire frequency domain information of the picture and determines a picture type of the picture according to a relationship between frequency domain information of the picture and a predetermined threshold. Accordingly, the disclosed embodiments determine the picture type of the picture based on the differences between the characteristics of a natural type and a composite type, which can be easily implemented with high accuracy. Also, after determining the picture as a composite type picture, the terminal switches the sRGB color gamut mode to the wide color gamut mode and adopts the wide color gamut mode to show the picture, thus the picture can be displayed with vivid colors, and the user viewing experiences may be improved.

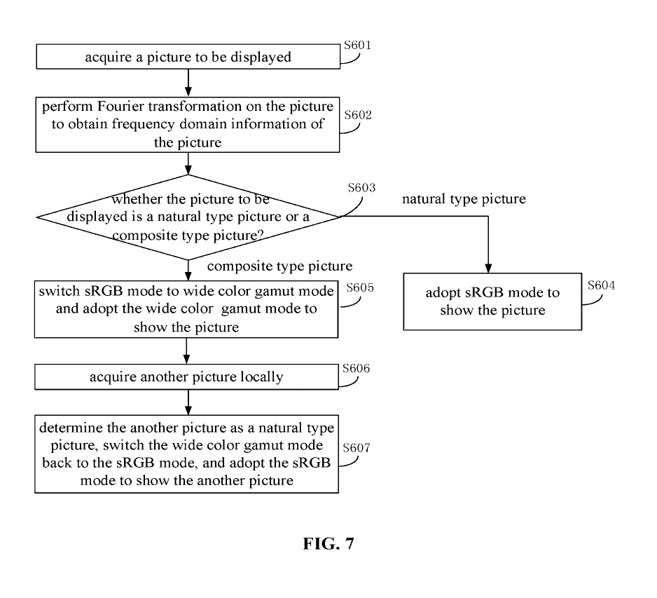

FIG. 7 is a flow chart of yet another example method for setting a color gamut mode according to an embodiment of the disclosure. As shown in FIG. 7, after step S605, the method may further include the following steps.

In step S606, another picture may be acquired by the terminal locally from a storage device of the terminal.

In step S607, the another picture may be determined as a natural type picture, and the color gamut mode may be switched from the wide color gamut mode back to the sRGB color gamut mode, and the sRGB mode may be adopted to show the another picture.

The above embodiment of the method for setting color gamut mode switches the color gamut mode from the wide color gamut mode back to the sRGB color gamut mode and adopts the sRGB mode to show another picture after determining the another picture as a natural type picture. Thus, the another picture can be displayed with accurate colors, and the user viewing experiences may be improved.

Corresponding to above embodiments of methods for setting a color gamut mode, the disclosure further provides embodiments of devices for setting a color gamut mode.

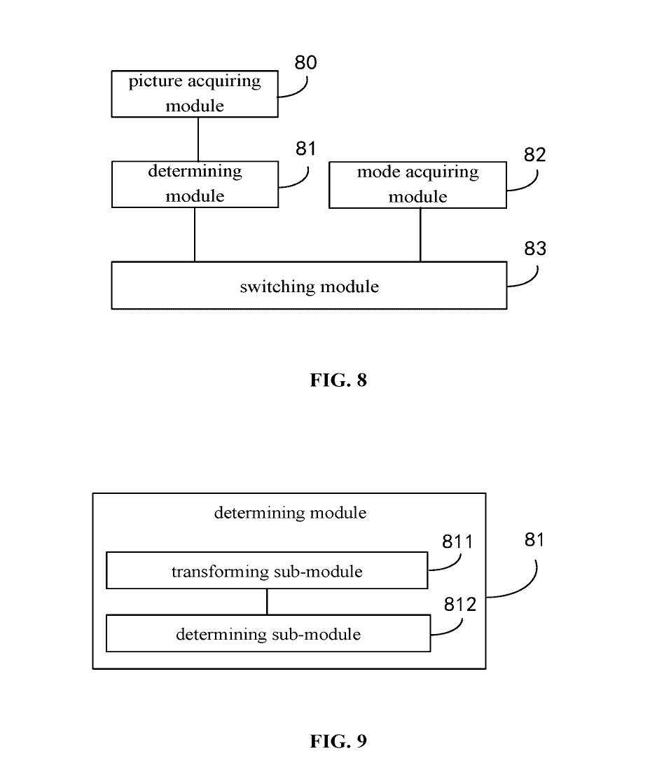

FIG. 8 is a block diagram of an example device for setting a color gamut mode according to an embodiment of the disclosure. As shown in FIG. 8, the device for setting a color gamut mode may include a picture acquiring module 80, a determining module 81, a mode acquiring module 82 and a switching module 83.

The picture acquiring module 80 may be configured to acquire a picture to be displayed.

The determining module 81 may be configured to determine a picture type of the picture to be displayed, which is acquired by the picture acquiring module 80.

The mode acquiring module 82 may be configured to acquire a current color gamut mode currently adopted by a terminal. In some embodiments, each picture type is associated with a respective, predetermined color gamut mode.

The switching module 83 may be configured to, when the picture type of the picture determined by the determining module 81 does not match the current color gamut mode acquired by the mode acquiring module 82, switch the color gamut mode from the current color gamut mode to a color gamut mode which matches the picture type of the picture.

In some embodiments, the determining module 81 may be configured to determine a picture type of the picture to be displayed according to frequency domain information of the picture to be displayed.

The procedure performed by the device in FIG. 8 for setting a color gamut mode is the same or similar to the relevant portions described in conjunction with FIGS. 1, 4, and 6, and the detailed description thereof is thus omitted.

In some examples, the device for setting a color gamut mode as described above acquires, by an acquiring module, a picture to be displayed, determines, by a determining module, a picture type of the picture, and switches, by a switching module, the color gamut mode adopted by the device from a current color gamut mode to a color gamut mode that matches the picture type of the picture to be displayed when the picture type does not match the current color gamut mode. The whole mode setting procedure can be performed automatically even when a user does not possess professional knowledge with respect to setting color gamut mode. Meanwhile, by adopting a matching color gamut mode based on a picture type of a picture, the colors of the picture can be displayed with the accuracy a user might expect, and the user viewing experiences may be improved.

FIG. 9 is a block diagram of an example determining module in a device for setting a color gamut mode according to an embodiment. As shown in FIG. 9, based on the embodiment shown in FIG. 8, the determining module 81 may include: a transforming sub-module 811 and a determining sub-module 812.

The transforming sub-module 811 may be configured to perform Fourier transformation on the picture to be displayed to acquire the frequency domain information.

The determining sub-module 812 may be configured to determine a picture type of the picture according to a relationship between the frequency domain information acquired by the transforming sub-module 811 and a predetermined threshold. In some example, the picture type includes a natural type and a composite type. In some examples, all normalized amplitude values of the frequency domain information of a natural type picture are less than the predetermined threshold. In contrast, in some examples, at least one normalized amplitude value of the frequency domain information of a composite type picture is greater than the predetermined threshold.

The procedure performed by the determining module 81 in FIG. 9 for determining a picture type of a picture is the same or similar to the relevant portions described in conjunction with FIGS. 1, 4, and 6, and the detailed description thereof is thus omitted

The above embodiment of the determining module 81 for determining a picture type performs makes, by a transforming sub-module, Fourier transformation on the picture to be displayed to acquire frequency domain information of the picture and determines, by a determining sub-module, a picture type of the picture according to a relationship between the frequency domain information of the picture and a predetermined threshold. Accordingly, the disclosed embodiments determine the picture type of the picture based on the differences between the characteristics of a natural type and a composite type, which can be easily implemented with high accuracy.

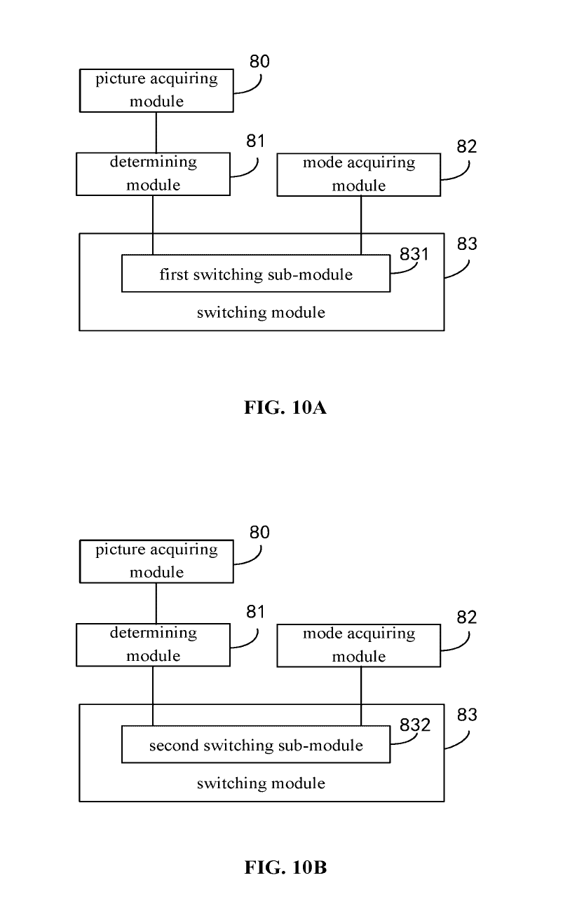

FIG. 10A is a block diagram of another example device for setting a color gamut mode according to an embodiment of the disclosure. As shown in FIG. 10A, based on the embodiment shown in FIG. 8, the switching module 83 may include: a first switching sub-module 831.

The first switching sub-module 831 may be configured to, when the picture type of the picture to be displayed belongs is a natural type and the current color gamut mode is the wide color gamut mode, determine that they do not match with each other and switch the color gamut mode adopted by the device from the wide color gamut mode to the sRGB color gamut mode, which matches the picture type of the picture to be displayed.

The procedure performed by the device in FIG. 10A for setting a color gamut mode is the same or similar to the relevant portions described in conjunction with FIGS. 1 and 4, and the detailed description thereof is thus omitted.

The above embodiment of the device for setting the color gamut mode may switch the color gamut mode adopted by the device from the wide color gamut mode to the sRGB color gamut mode and adopt the sRGB color gamut mode to show a picture to be displayed after determining the picture to be displayed as a natural type picture. As such, the colors of the picture can be displayed with the accuracy a user might expect, and the user viewing experiences may be improved.

FIG. 10B is a block diagram of another example device for setting a color gamut mode according to an embodiment of the disclosure. As shown in FIG. 10B, based on the embodiment shown in FIG. 8, the switching module 83 may include: a second switching sub-module 832.

The second switching sub-module 832 may be configured to, when the picture type of the picture to be displayed belongs is a composite type and the current color gamut mode is the sRGB color gamut mode, determine that they do not match with each other and switch the color gamut mode adopted by the device from the sRGB color gamut mode to the wide color gamut mode, which matches the picture type of the picture to be displayed.

The procedure performed by the device in FIG. 10B for setting a color gamut mode is the same or similar to the relevant portions described in conjunction with FIGS. 1 and 6, and the detailed description thereof is thus omitted.

The above embodiment of the device for setting the color gamut mode may switch the color gamut mode adopted by the device from the sRGB color gamut mode to the wide color gamut mode and adopt the wide color gamut mode to show a picture to be displayed after determining the picture to be displayed as a composite type picture. As such, the colors of the picture can be displayed with the accuracy a user might expect, and the user viewing experiences may be improved.

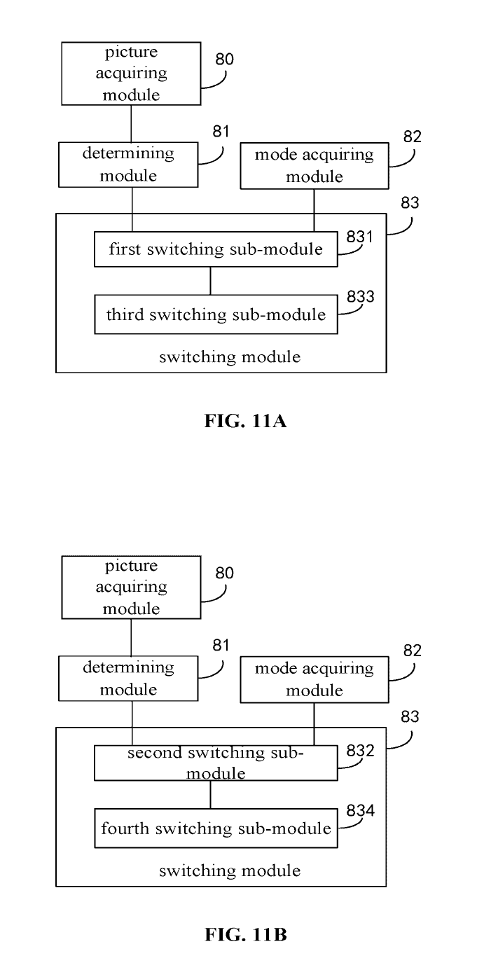

FIG. 11A is a block diagram of another example device for setting a color gamut mode according to an embodiment of the disclosure. As shown in FIG. 11A, based on the embodiment shown in FIG. 10A, the switching module 83 may further include: a third switching sub-module 833.

The third switching sub-module 833 may be configured to, after the first switching sub-module 831 switches the color gamut mode adopted by the device from the wide color gamut mode to the sRGB color gamut mode, if it is determined that another picture to be displayed is a composite type picture, switch the color gamut mode adopted by the device from the sRGB color gamut mode back to the wide color gamut mode.

The procedure performed by the device in FIG. 11A for setting a color gamut mode is the same or similar to the relevant portions described in conjunction with FIG. 5, and the detailed description thereof is thus omitted.

The above embodiment of the device for setting the color gamut mode may switch the color gamut mode adopted by the device from the sRGB color gamut mode back to wide color gamut mode and adopt the wide color gamut mode to show a picture to be displayed after determining the picture to be displayed as a composite type picture. As such, the colors of the picture can be displayed with the vivid colors, and the user viewing experiences may be improved.

FIG. 11B is a block diagram of still another example device for setting a color gamut mode according to an embodiment of the disclosure. As shown in FIG. 11B, based on the embodiment shown in FIG. 10B, the switching module 83 may further include: a fourth switching sub-module 834.

The fourth switching sub-module 834 may be configured to, after the second switching sub-module 832 switches the color gamut mode adopted by the device from the sRGB color gamut mode to the wide color gamut mode, if it is determined that another picture to be displayed is a natural type picture, switch the color gamut mode adopted by the device from the wide color gamut mode back to the sRGB color gamut mode.

The procedure performed by the device in FIG. 11B for setting a color gamut mode is the same or similar to the relevant portions described in conjunction with FIG. 7, and the detailed description thereof is thus omitted.

The above embodiment of the device for setting the color gamut mode may switch the color gamut mode adopted by the device from the wide color gamut mode back to the sRGB color gamut mode and adopt the sRGB color gamut mode to show a picture to be displayed after determining the picture to be displayed as a natural type picture. As such, the colors of the picture can be displayed with the accuracy a user might expect.

With respect to the devices in above embodiments, specific manners in which respective modules and sub-modules perform operations have been described in detail in embodiments related to methods, which will not be elaborated herein.

It is noted that any one of the modules or sub-modules described in this disclosure can be implemented as hardware, software, or a combination of hardware and software. In an example, some or all of the modules or sub-modules in the FIGS. 8-11B are implemented as processing circuitry executing software instructions.

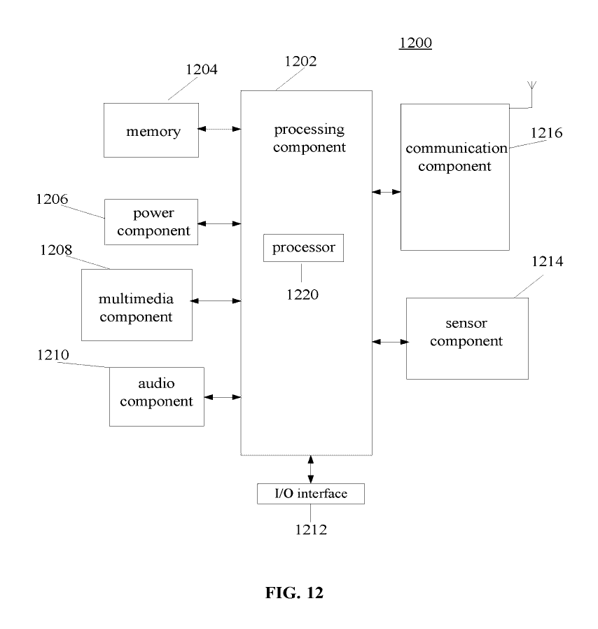

FIG. 12 is a block diagram of an example apparatus usable as a device for setting a color gamut mode according to an embodiment of the disclosure. For example, apparatus 1200 may be a mobile phone, a computer, a digital broadcast terminal, a messaging device, a gaming console, a tablet, a medical device, exercise equipment, a personal digital assistant, an aircraft, and the like.

Referring to FIG. 12, the apparatus 1200 may include one or more of the following components: a processing component 1202, a memory 1204, a power component 1206, a multimedia component 1208, an audio component 1210, an input/output (I/O) interface 1212, a sensor component 1214, and a communication component 1216. It is noted that any one of the components described in this disclosure can be implemented as hardware, software, or a combination of hardware and software.

The processing component 1202 typically controls overall operations of the apparatus 1200, such as the operations associated with display, telephone calls, data communications, camera operations, and recording operations. The processing component 1202 may include one or more processors 1220 to execute instructions to perform all or part of the steps described in the present disclosure. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The memory 1204 is configured to store various types of data to support the operation of the apparatus 1200. Examples of such data include instructions for any applications or methods operated on the apparatus 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power management system, one or more power sources, and any other components associated with the generation, management, and distribution of power in the apparatus 1200.

The multimedia component 1208 includes a display device providing an output interface between the apparatus 1200 and the user. In some embodiments, the display device may include a liquid crystal display (LCD) and a touch panel (TP). If the display device includes the touch panel, the display device may be implemented as a touch screen display to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive an external multimedia datum while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the device 1200, a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the apparatus 1200 and other devices. The apparatus 1200 can access a wireless network based on a communication standard, such as WiFi, 2G, or 3G, or a combination thereof In one exemplary embodiment, the communication component 1216 receives a broadcast signal or broadcast associated information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, there is also provided a non-transitory computer-readable storage medium including instructions, such as included in the memory 1204, executable by the processor 1220 in the apparatus 1200, for performing the above-described methods. For example, the non-transitory computer-readable storage medium may be a ROM, a RAM, a CD-ROM, a magnetic tape, a floppy disc, an optical data storage device, and the like.

Other embodiments will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and embodiments be considered as only for illustrative purposes.

It should be understood that the disclosure is not limited to the exact structure as described above and illustrated in the figures, and that various modifications and changes can be made without departing from the scope of the disclosure. The scope of the disclosure is limited only by the appended claims.

What is claimed is:

1. A method for setting a color gamut mode for driving a display, comprising:
acquiring a first picture to be displayed on the display;
determining a picture type of the first picture, the picture type being associated with a predetermined color gamut mode;
acquiring a current color gamut mode currently adopted for driving the display; and
when the picture type of the first picture does not match the current color gamut mode, switching the color gamut mode for driving the display from the current color gamut mode to the predetermined color gamut mode.

2. The method of claim 1, wherein determining the picture type of the first picture includes:
determining the picture type of the first picture according to frequency domain information of the first picture.

3. The method of claim 2, wherein determining the picture type of the first picture according to the frequency domain information of the first picture includes:
performing Fourier transformation on the first picture to acquire the frequency domain information; and
determining the picture type of the picture according to a relationship between the frequency domain information and a predetermined threshold, wherein
the picture type includes a natural type and a composite type, and
determining the picture type includes
determining the picture type being the natural type when all normalized amplitude values of the frequency domain information are less than the predetermined threshold, and
determining the picture type being the composite type when at least one normalized amplitude value of the frequency domain information is greater than the predetermined threshold.

4. The method of claim 1, wherein
the picture type includes a natural type and a composite type;
the natural type is associated with a first color gamut mode; and
the composite type is associated with a second color gamut mode that corresponds to a wider color space than the first color gamut mode.

5. The method of claim 4, wherein
the first color gamut mode is a standard Red Green Blue (sRGB) color gamut mode.

6. The method of claim 1, further comprising:
driving the display to display the first picture based on the predetermined color gamut mode;
acquiring a second picture to be displayed on the display after the first picture is displayed; and
when a picture type of the second picture does not match the predetermined color gamut mode, switching the color gamut mode for driving the display from the predetermined color gamut mode to the color gamut mode with which the picture type of the second picture is associated.

7. The method of claim 7, further comprising:
driving the display to display the second picture based on the color gamut mode with which the picture type of the second picture is associated.

8. A device for setting a color gamut mode for driving a display, comprising:
a processor; and
a memory storing instructions executable by the processor;
wherein the processor is configured to:
acquire a first picture to be displayed on the display;
determine a picture type of the picture, the picture type being associated with a predetermined color gamut mode;
acquire a current color gamut mode currently adopted for driving the display; and
when the picture type of the first picture does not match the current color gamut mode, switch the color gamut mode for driving the display from the current color gamut mode to the predetermined color gamut mode

9. The device of claim 8, wherein the processor is configured to:
determine the picture type of the first picture according to frequency domain information of the first picture.

10. The device of claim 9, wherein, when determining the picture type of the first picture, the processor is configured to:
perform Fourier transformation on the first picture to acquire the frequency domain information; and
determine the picture type of the picture according to a relationship between the frequency domain information and a predetermined threshold, wherein
the picture type includes a natural type and a composite type, and
when determining the picture type of the first picture, the processor is configured to
determine the picture type being the natural type when all normalized amplitude values of the frequency domain information are less than the predetermined threshold, and
determine the picture type being the composite type when at least one normalized amplitude value of the frequency domain information is greater than the predetermined threshold

11. The device of claim 8, wherein
the picture type includes a natural type and a composite type;
the natural type is associated with a first color gamut mode; and
the composite type is associated with a second color gamut mode that corresponds to a wider color space than the first color gamut mode.

12. The device of claim 11, wherein
the first color gamut mode is a standard Red Green Blue (sRGB) color gamut mode.

13. The device of claim 8, wherein the processor is configured to:
drive the display to display the first picture based on the predetermined color gamut mode;
acquire a second picture to be displayed on the display after the first picture is displayed; and
when a picture type of the second picture does not match the predetermined color gamut mode, switch the color gamut mode for driving the display from the predetermined color gamut mode to the color gamut mode with which the picture type of the second picture is associated.

14. The device of claim 13, wherein the processor is configured to:
drive the display to display the second picture based on the color gamut mode with which the picture type of the second picture is associated.

15. A non-transitory computer-readable medium having recorded thereon a computer program including instructions, which when executed by a computer, cause the computer to perform a method, the method comprising:
acquiring a first picture to be displayed on a display;
determining a picture type of the first picture, the picture type being associated with a predetermined color gamut mode;
acquiring a current color gamut mode currently adopted for driving the display; and
when the picture type of the first picture does not match the current color gamut mode, switching a color gamut mode for driving the display from the current color gamut mode to the predetermined color gamut mode.

16. The non-transitory computer-readable medium of claim 15, wherein determining the picture type of the first picture includes:
determining the picture type according to frequency domain information of the first picture.

17. The non-transitory computer-readable medium of claim 16, wherein determining the picture type of the first picture according to the frequency domain information of the first picture includes:
performing Fourier transformation on the first picture to acquire the frequency domain information; and
determining the picture type of the first picture according to a relationship between the frequency domain information and a predetermined threshold, wherein
the picture type includes a natural type and a composite type, and
determining the picture type includes
determining the picture type being the natural type when all normalized amplitude values of the frequency domain information are less than the predetermined threshold, and
determining the picture type being the composite type when at least one normalized amplitude value of the frequency domain information is greater than the predetermined threshold.

18. The non-transitory computer-readable medium of claim 15, wherein
the picture type includes a natural type and a composite type;
the natural type is associated with a first color gamut mode; and
the composite type is associated with a second color gamut mode that corresponds to a wider color space than the first color gamut mode.

19. The non-transitory computer-readable medium of claim 18, wherein
the first color gamut mode is a standard Red Green Blue (sRGB) color gamut mode.

20. The non-transitory computer-readable medium of claim 1, wherein the method further comprises:
driving the display to display the first picture based on the predetermined color gamut mode;
acquiring a second picture to be displayed on the display after the first picture is displayed; and
when a picture type of the second picture does not match the predetermined color gamut mode, switching the color gamut mode for driving the display from the predetermined color gamut mode to the color gamut mode with which the picture type of the second picture is associated.
